(19) United States
(12) Patent Application Publication
(10) Pub. No.: US 2014/0304186 A1
(43) Pub. Date: Oct. 9, 2014

(54) Directed Charitable Giving System

(71) Applicant: Nicholas Anthony Lindsay Brown, Petaluma, CA (US)

(72) Inventor: Nicholas Anthony Lindsay Brown, Petaluma, CA (US)

(21) Appl. No.: 13/857,557

(22) Filed: Apr. 5, 2013

(51) Int. Cl. G06Q 30/02

(52) U.S. Cl. CPC G06Q 30/0279
USPC 705/329

(57) ABSTRACT

A directed giving system allows a giver to conveniently manage their one-time and recurring gift giving, where the giver can easily find the desired beneficiary and/or project, and where the giver is in complete control of the entire process. A giver can configure a single or recurring gift in their bank's bill pay system or employers payroll system, and then configure the distribution of gifts in a gift processing system. The distribution of gifts can be single or recurring, and the distribution can be for a specific beneficiary or for a project. It may also be possible for the beneficiary to receive funds as a loan rather than a gift, where the loan is repaid and the funds can then be given or lent to another beneficiary. The system can also produce consolidated charitable receipts for the giver for tax purposes.

### BACKGROUND OF INVENTION

The present invention is in the field of giving charitable gifts to desired beneficiaries using electronic methods.

There have been many advances over recent years in the area of making electronic payments for purchases and services. These have included credit/debit cards, and automated bill pay. While useful for making purchases and paying bills, these have limited value for charitable donations.

The most desired method of making gifts that is not easily available is recurring gifts of small amounts. The obvious example is church donations every week. Another example is giving $20 per month to a local soup kitchen, or to the Salvation Army. The value to the beneficiary is the knowledge of recurring gift receipts, allowing the beneficiary to be able to plan for the future with more certainty.

Most gift giving currently is limited to donating cash and writing checks. While these methods work fine, there are some drawbacks. The giver must have the desired cash available, or go through the process of writing a check. The beneficiary must process the cash or check, keep a record of it, and possibly produce a charitable donation receipt for the giver for tax purposes. The giver may also need to manage their giving information for tax purposes. The biggest drawback is the giver must remember to make the gift every single time they wish to make the gift.

Credit/debit cards are available as a method of gift giving, but these have other disadvantages. One of the benefits is the ease of making the gift, provided the beneficiary can process the card. There is also a big benefit of setting up a recurring gift. However, the beneficiary is now responsible for processing the transaction and securing the received card information, and the giver must be comfortable with giving their card information to the beneficiary. There is the risk of a giver going into debt based on excessive giving using credit cards. There is the risk of overdraft fees if there are insufficient funds for a debit card transaction. There is also the risk of the giver desiring to terminate the gift giving, but the beneficiary continuing to process the recurring transactions whether intentionally or unintentionally. Finally, the beneficiary is charged a high transaction fee based on the transaction typically being for a purchase of goods/services where chargebacks and reversals are a potential, not something that would happen for gift giving.

### SUMMARY OF THE INVENTION

The present invention is an automated gift processing network, which allows the giver to conveniently manage their one-time and recurring gift giving, where the giver can easily find the desired beneficiary and/or project, and where the giver is in complete control of the entire process.

The core of the automated gift processing network consists of an gift processing system managed by a gift management organization. The giver transfers funds to the gift management organization, and configures within the gift processing system the destination beneficiaries of the gift. The gift management organization then transfers funds to the appropriate beneficiary at the appropriate time. The giver can then receive from the gift management organization a charitable receipt containing details of all the amounts donated.

The transfers of funds to the gift management organization is managed by the giver. One method of managing one-time or recurring funds transfers is using the online bill pay system available at the giver's existing bank. Alternatively, recurring funds transfers can be configured in a payroll processing system utilized by the giver's employer. Other funds transfer methods can also be used.

A core value of this present invention is the ability for the giver to configure recurring gift giving, first as recurring funds transfers into the gift processing system, then as recurring gifts to specified beneficiaries within the gift processing system.

In one preferred embodiment of the present invention, the gift management organization that manages the gift processing system can be structured as a non-profit organization. This allows for all funds transferred to the gift processing network to be considered charitable donations to a single source regardless of the final destination of the gifts, and allows for a single charitable receipt for all gifts.

In another preferred embodiment of the present invention, the giver can request funds to be lent to a beneficiary, where the gift management organization lends funds to the beneficiary. The beneficiary will repay the loan at a later time, and the repaid funds can then be gifted or lent to another beneficiary.

In another preferred embodiment of the current invention, the giver can make a gift anonymously to the beneficiary while still receiving a charitable receipt for the gift.

### BRIEF DESCRIPTION OF THE DRAWINGS

FIG. 1 is a schematic diagram of one preferred embodiment of the components of the present invention, utilizing a giver bill pay system for funds transfers.

FIG. 2 is a flow chart of one preferred embodiment of the present invention, utilizing a giver bill pay system for funds transfers.

FIG. 3 is a schematic diagram of one preferred embodiment of the components of the present invention, utilizing a giver payroll system for funds transfers.

FIG. 4 is a flow chart of one preferred embodiment of the present invention, utilizing a giver payroll system for funds transfers.

FIG. 5 is an example of a bill payment page in a bank web site showing a recurring payment to the gift management organization.

FIG. 6 is an example of an allocation page in the gift processing system web site showing scheduled and past gifts to beneficiaries.

### DETAILED DESCRIPTION OF THE INVENTION

The present invention is an automated gift processing network, which allows the giver 100 to conveniently manage their one-time and recurring gift giving, where the giver 100 can easily find the desired beneficiary 110 and/or project, and where the giver 100 is in complete control of the entire process.

The core of the automated gift processing network consists of an gift processing system 310 managed by a gift management organization 300. The giver 100 transfers funds to the gift management organization 300, and configures within the gift processing system 310 the destination beneficiaries 110 of the gift. The gift management organization 300 then transfers funds to the appropriate beneficiary 110 at the appropriate time. The giver 100 can then receive from the gift management organization 300 a charitable receipt containing details of all the amounts donated.

FIG. 1 is a schematic diagram of one preferred embodiment of the present invention, utilizing a giver bill pay system 210 for funds transfers. The purpose of this embodiment of the present invention is for the giver 100 to make a single or recurring gift to the beneficiary 110, whereby funds are withdrawn from the giver account 220 at the giver financial institution 200 and deposited into the beneficiary account 420 at the beneficiary financial institution 400. The giver 100 accomplishes this by utilizing the bill pay system 210 at the giver financial institution 200, to transfer funds to an account 320 at the gift management organization 300. The giver 100 also creates an ID in the gift processing system 310 managed by the gift management organization 300, arranging for the transfer of gifted funds to the beneficiary 110.

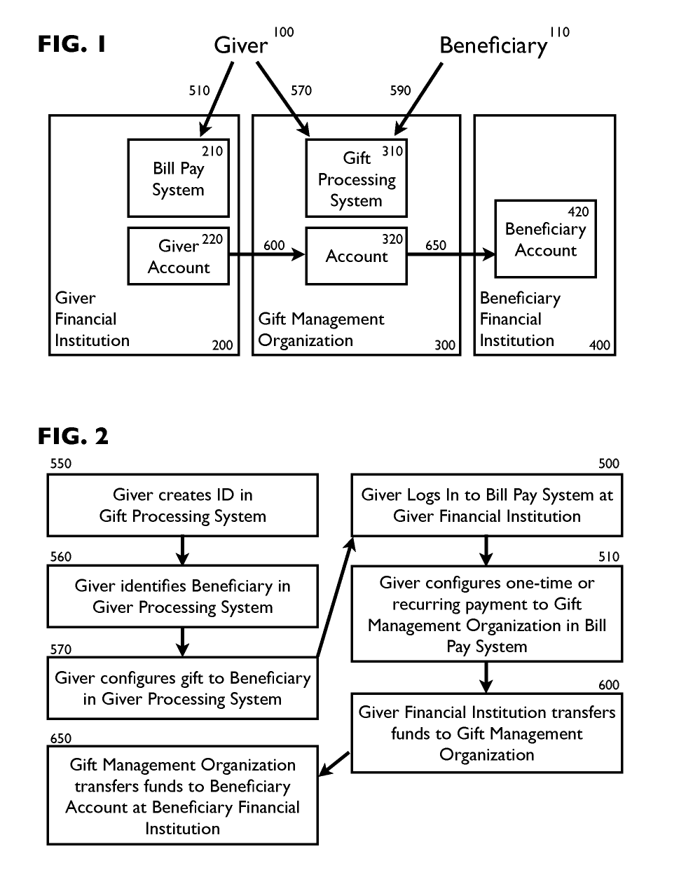

FIG. 2 is a flow chart of one preferred embodiment of the present invention, utilizing a giver bill pay system 210 for funds transfers. The following steps accomplish the purpose described in FIG. 1 of a giver 100 making a single or recurring gift to a beneficiary. STEP 550 the giver 100 creates a giver ID 102 in the gift processing system 310. STEP 560 the giver 100 identifies a beneficiary 110 in the gift processing system 310. The beneficiary 110 must have previously configured themselves 590 into the gift processing system 310 creating a beneficiary ID 112. STEP 570 the giver 100 configures a single or recurring gift to the beneficiary 110 in the gift processing system 310. STEP 500 the giver 100 logs into the bill pay system 210 at the giver financial institution 200. STEP 510 the giver 100 configures a single or recurring payment to the gift management organization 300 in the bill pay system 210 of the giver financial institution 200. STEP 600 at the appointed time, the giver financial institution 200 transfers funds from the giver account 220 to the account 320 of the gift management organization 300. STEP 650 at the appropriate time the gift management organization 300 transfers funds to the beneficiary account 420 at the beneficiary financial institution 400.

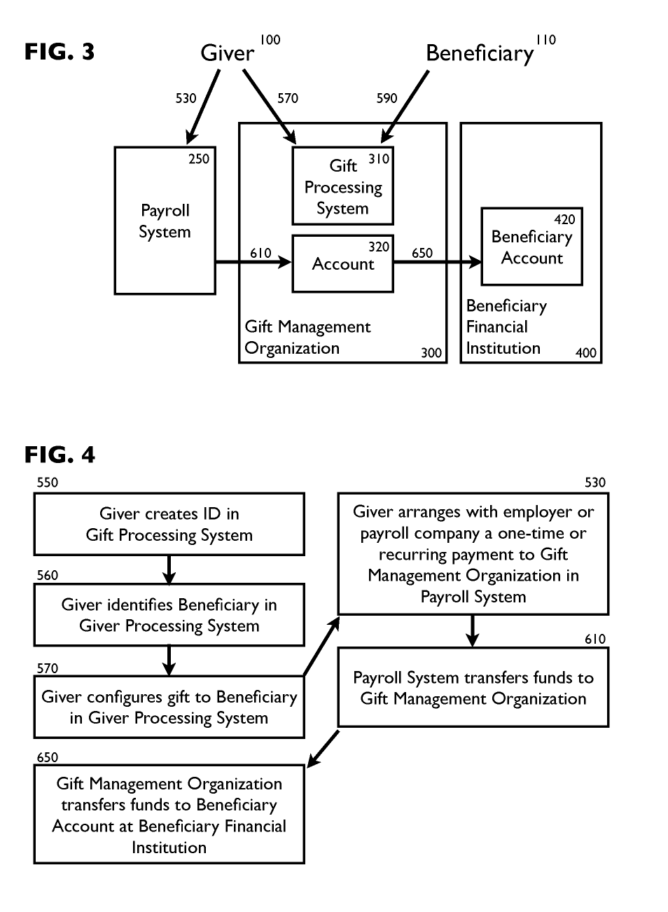

FIG. 3 is a schematic diagram of one preferred embodiment of the present invention, utilizing a giver payroll system 250 for funds transfers. The purpose of this embodiment of the present invention is for the giver 100 to make a single or recurring gift to the beneficiary 110, whereby funds are withheld from the giver paycheck by the payroll system 250 and deposited into the beneficiary account 420 at the beneficiary financial institution 400. The giver 100 accomplishes this by utilizing the payroll system 250 used by their employer, to withhold funds from the giver 100 paycheck and transfer these funds to an account 320 at the gift management organization 300. The giver 100 also creates an ID in the gift processing system 310 managed by the gift management organization 300, arranging for the transfer of gifted funds to the beneficiary 110.

FIG. 4 is a flow chart of one preferred embodiment of the present invention, utilizing a giver payroll system 250 for funds transfers. The following steps accomplish the purpose described in FIG. 3 of a giver 100 making a single or recurring gift to a beneficiary. STEP 550 the giver 100 creates a giver ID 102 in the gift processing system 310. STEP 560 the giver 100 identifies a beneficiary 110 in the gift processing system 310. The beneficiary 110 must have previously configured themselves 590 into the gift processing system 310 creating a beneficiary ID 112. STEP 570 the giver 100 configures a single or recurring gift to the beneficiary 110 in the gift processing system 310. STEP 530 the giver 100 arranges with their employer to utilize the employer payroll system 250 to direct certain funds to the gift management organization 300 on a one-time or recurring basis. STEP 610 at the appropriate time, the payroll system 250 transfers funds to the account 320 of the gift management organization 300. STEP 650 at the appropriate time the gift management organization 300 transfers funds to the beneficiary account 420 at the beneficiary financial institution 400.

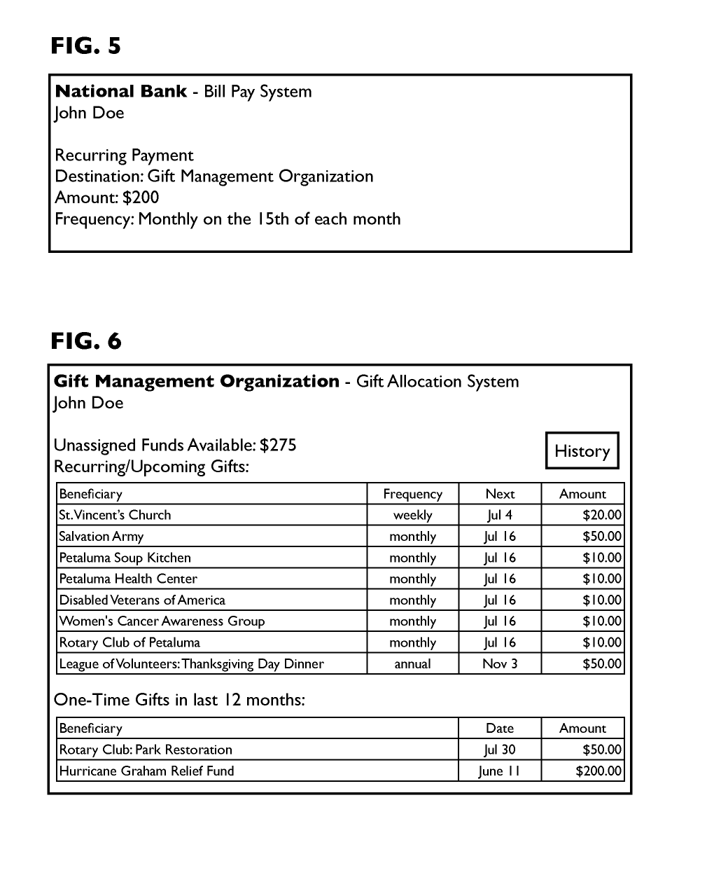

FIG. 5 shows an example bill payment page in a giver financial institution 200 web site showing a recurring payment of $200 from a giver 100 to the gift management organization 300 on the 15th of each month. This is a fairly easy method of setting up a recurring manageable charitable donation from the giver's 100 income.

FIG. 6 shows an example allocation page in the gift processing system 310 web site showing the giver's 100 scheduled and past gifts to beneficiaries 110 and beneficiary projects 115. One of the values of this system is the ability for a giver 100 to assign a set aside a specific amount each month for charitable donations, and then to decide the beneficiaries of that amount, allowing the giver 100 to make multiple smaller donations to different beneficiaries 110.

Step 590 Configuring a Beneficiary

A beneficiary 110 must be configured within the gift processing system 310 in order to receive gifts from givers 100. As part of the configuration process, a beneficiary ID 112 can be created. It may be necessary for the beneficiary 110 to provide non-profit information if applicable.

It may be possible for a beneficiary 110 to create specific beneficiary projects 115, allowing the giver 100 to give to the beneficiary 110 or to a specific beneficiary project 115. A beneficiary project 115 may have a beneficiary project ID 117. A beneficiary project 115 may or may not have an end date. A beneficiary project 115 may or may not have a target amount, and if there is a target amount then the amount raised may or may not be allowed to exceed the amount target. A beneficiary project 115 may happen once, or may be recurring. The description of the beneficiary project 115 and conditions may or may not be able to be changed at a later time.

There may be tangible or intangible benefits to the giver 100 provided by the beneficiary 110. These benefits may be reported in relevant tax receipts dependent on the tax laws of the relevant country.

Step 560 Identifying a Beneficiary

There are several methods of identifying a beneficiary 110 in the gift processing system 310.

The giver 100 may be able to do a beneficiary search in the gift processing system 310 web site on any one or more of the following: name, location (town, country, state and/or country), project name, project type, beneficiary type, beneficiary goals, or some other identifier. Other technology and sites may be used with a similar process and result.

The giver 100 may be able to go to the beneficiary 110 web site and be presented with a link to the gift processing system 310 web site on a page specific to the beneficiary 110. Other technology and sites may be used with a similar process and result.

The giver 100 may receive from the beneficiary 110 the beneficiary ID 112, and enter it directly into the gift processing system 310 web site. Other technology and sites may be used with a similar process and result.

The giver 100 may identify a beneficiary 110 or beneficiary project 115 as the receiver of a gift.

Step 570 Configure Gift to a Beneficiary

A gift to a beneficiary 110 or beneficiary project 115 can be a single transfer, or can be recurring. A recurring gift can be daily, weekly, every 2 weeks, twice a month, monthly, quarterly, annually, or some other frequency. A gift can be configured to happen on a specific date, or on receipt of a deposit of funds made in the name of the giver 100. The amount of the gift can be a specific amount or related to the remaining balance available to give.

The giver 100 may be able to request the giver 100 be anonymous to the beneficiary 110.

Step 510 Configuring bill payments

A gift to a beneficiary can be a single transfer, or can be recurring. A recurring gift can be daily, weekly, every 2 weeks, twice a month, monthly, quarterly, annually, or some other frequency. A gift can be configured to happen on a specific date, or on receipt of a deposit of funds made in the name of the giver 100.

The giver 100 should identify all gifts as from the giver 100, in order for the gift processing system 310 to recognize the source giver 100 of the funds. It is likely that any unidentified gifts received by the gift management organization 300 will be treated as anonymous gifts to the gift management organization 300.

The gift processing system 310 may be configured so that the giver 100 is able to identify a specific beneficiary 110 or beneficiary project 115 with the gift. The gift processing system 310 would then be able to identify the giver 100 and the beneficiary 110 or beneficiary project 115, superseding any configuration

Step 650 Transferring funds to Beneficiary

The beneficiary 110 may identify a beneficiary account 420 at a beneficiary financial institution 400 so that funds are transferred directly into the beneficiary account 420. The beneficiary 110 may provide name and address information so that a check can be sent to the beneficiary 110, and the check deposited by the beneficiary into the beneficiary account 420.

Funds are made available to the beneficiary 110 as soon as funds are made available by the giver 100 as configured in STEP 570. Funds may be delayed if the funds have not arrived from the giver 100, or if the funds have arrived but have not been cleared. Funds may not be made available to the beneficiary 110 if the funds are for a beneficiary project 115 if there is a target date or amount, where the target has not been reached.

Funds may be transferred to the beneficiary 110 immediately on funds being made available to the beneficiary 110, or delayed. Funds could be consolidated into a single transfer with other funds. Funds could be sent periodically (daily, weekly, monthly, etc.). Funds could be sent when certain conditions are met, for example reaching a minimum amount, or no more than once a month. Funds transfers could be delayed until requested.

There may be a charge against the gift amount for processing and/or the funds transfer process.

Types of Givers 100

There is likely to be no restriction on the types of givers 100. A giver 100 can be an individual, a couple, a family, a group of people, an organization, a non-profit, a church, or something else. It is possible for a giver 100 to also be registered in the gift processing system 310 as a beneficiary 110.

Types of Beneficiaries 110 and Beneficiary Projects 115

Beneficiaries 110 should be non-profit organizations under the tax law of the appropriate country. These may include churches. These should be registered in the appropriate government institution.

It may be necessary for beneficiary projects 115 to fit into specific government defined categories for them to be considered suitable to be classified as gifts under tax law.

It may be possible for other types of organizations to be configured in the system as beneficiaries. The taxable implications of these organizations and/or projects must be taken into account. It could be that gifts to these organizations/projects are not considered charitable gifts, for both the giver 100 and the organization/project.

It may be possible for individuals (or groups of individuals) to be configured in the system as beneficiaries. The taxable implications of these individuals and/or projects must be taken into account. It could be that gifts to these individuals/projects are not considered charitable gifts, for both the giver 100 and the individual/project. For example, a gift may be made to an individual for the purpose of cleaning a park or stream, or writing a book about a specific subject.

It may be that a gift to a beneficiary 110 is considered a grant or scholarship or some other term rather than a charitable gift. The tax and other legal regulations around these must be carefully scrutinized.

It may be that funds for a beneficiary project 115 (or possibly a beneficiary 110) be for a specific purpose, where donated funds are not directed to the beneficiary 110 but rather to a different destination relating to the beneficiary project 115. For example, an organization may have a project raising money for dictionaries for children, where the raised money could go directly to the publisher/distributor of the dictionaries rather than the organization.

It may be that there is a tangible or intangible benefit to the giver 100 provided by the beneficiary 110 for a gift. The benefit to the giver 100 may vary dependent on the size of the gift. For example, a gift to a church for a refurbishing project, where $100 gets you a mention by the minister the next sunday, $1000 gets your name inscribed as a donor by the front door, and $10,000 gets your name on a stained glass window. Another example may be a gift to a writer to write a book, where $10 will get you a copy of the book once completed, $25 will get you a signed copy, and $100 will also get you all the other books the writer has written to date.

Loans

It may be that rather than a donation to a beneficiary 110, the beneficiary 110 may receive funds as a loan. It would then be necessary for the beneficiary 110 to repay the loan, possibly with interest and other loan fees. Once some or all of the loan has been repaid, the funds may be available to the giver 100 to give to another beneficiary 110. The tax ramification must be considered in these instances.

Charitable Receipts for Tax Purposes

Different countries have different tax rules regarding charitable donations. A charitable receipt may be available for a specific giver 100 in a specific country. If available, the relevant information will be collected and a charitable receipt provided by the gift management organization 300 to the giver 100.

The charitable receipt for the giver 100 may specify each individual gift to each beneficiary 110, combine all gifts to each beneficiary 110, or may combine gifts to multiple beneficiaries 110 into a single amount. Gifts to beneficiary projects 115 may be separately itemized, or combined with others or with the beneficiary 110.

If there are any tangible or intangible benefits to the giver 100 provided by the beneficiary 110, it may be necessary for these benefits to be detailed in the charitable receipt dependent on the tax laws of the relevant country.

The giver 100 may receive a single charitable receipt for the year, or multiple.

If the gift management organization 300 is structured as a non-profit organization, gifts received may be classified as gifts to the gift management organization 300, and a charitable receipt may be produced which identifies all gifts as having been given to the gift management organization 300.

Funds Transfers to Gift Management Organization 300

Above are described two different methods of transferring funds to the gift management system 300: using a bill pay system 210 and a payroll system 250.

Other methods could include but are not limited to the following: credit/debit cards, bank transfers (ACH, SWIFT, Wires, etc.), checks, ATM or point of sale (POS) transfers, cash deposits, and other funds transfer systems around the world. As new technologies appear, other funds transfer systems may be possible.

There may be a charge against the gift amount for the funds transfer process.

Classification of Gifts

It is possible that gifts are considered to be official gifts from the moment they arrive in the account 320 of the gift management organization 300. They will then be classified as gifts to the gift management organization 300 until they are assigned by the giver 100 to a specific beneficiary 110 or beneficiary project 115, or are abandoned. A gift that has not been identified, or has not been assigned to a beneficiary 110 or beneficiary project 115 within a certain amount of time may be considered abandoned by the gift management organization 300, and either considered a gift to the gift management organization 300 or given to a specific beneficiary 110 or beneficiary project 115 at the discretion of the gift management organization 300.

It is possible that gifts are not considered gifts until they have been assigned to a beneficiary 110 or beneficiary project 115, or until the beneficiary 110 has received the funds. In this case any funds received from the giver 100 that have not yet been classified as gifts may be considered to be residing in an account of the giver 100 at the gift management organization 300. It may be possible for unassigned funds to be returned to the giver 100.

It may be possible for givers 100 to make gifts other than currency to the gift management organization. If this is the case, it will be necessary for the value of the received gift be determined. Alternatively, it may be possible for the gift to be passed on to a specified beneficiary 110 or beneficiary project 115, where information may be obtained for tax reporting purposes.

International gift giving is possible, though the tax ramifications must be considered.

Communication from Gift Management Organization 300

The gift management organization 300 is likely to communicate with a giver 100 under some or all of the following conditions: giver 100 configuration, change of configuration, receipt of gift, assignment of gift, unassigned balance, repayment of loan made to a beneficiary, expiration of funds, notice of insufficient of funds for desired gifts, notice of missed expected receipt of funds, status update of beneficiary 110, return of funds from beneficiary 110 due to missed target, return of funds from beneficiary 110 due to cancelled project, return of funds from beneficiary 110 due to excessive funds raised, charitable receipt. There may be many other reasons for communication with the giver 100.

The gift management organization 300 is likely to communicate with a beneficiary 110 under some or all of the following conditions: beneficiary 110 configuration, beneficiary project configuration 115, change of configuration, receipt of gift, clearing of gift, funds transfer to beneficiary 110, status of fundraising, status of beneficiary project 115, expiration of funds, return of funds to giver 100 due to missed target, return of funds to giver 100 due to cancelled project, return of funds to giver 100 due to excessive funds raised. There may be many other reasons for communication with the beneficiary 110.

Communication Between Givers 100 and Beneficiaries 110

There may be many reasons for a giver 100 and a beneficiary to communicate. The gift processing system 310 may provide a means for this communication to take place. It may be possible for communication to happen while retaining the anonymity of the giver 100 if required.

Communication from a beneficiary 110 to a giver 100 may include some or all of the following: status update of beneficiary 110, status update of fundraising, starting of a new beneficiary project 115, status update of beneficiary project 115, thank you message for received gifts, information about benefits provided to giver 100, status of beneficiary 110 or beneficiary project 115, general communication.

Communication from a giver 100 to a beneficiary 110 may include some or all of the following: status update of giver 100, change of recurring gifts, special requests, general communication.

There may be many other reasons for communication between the beneficiary 110 and the giver 100.

Gift Project Platform

It may be possible for there to be a gift project platform allowing potential projects to be presented by organizations, beneficiaries 110 to select a desired project, and givers 100 to provide gifts or loans to accommodate beneficiary 110 adopting the desired project. It may be that while a gift made directly to the beneficiary 110 would not be considered a charitable donation, a gift processed through the gift management organization 300 would be.

For example, a farmer in Africa may have need of a well system to ensure reliable access to water and therefore reliable growing of crops, but be unable to afford it. A company may have produced a suitable well system, and present it on the gift project platform. The farmer searches and finds the well system in the gift project platform and requests funding, putting up 10% of the cost himself. Givers 100 can then look in the gift project platform, searching for project types (well systems) and/or locations (Africa) and/or beneficiary 110 types (farming) and/or gift type (loan 10% down) and/or other criterion, and find potential beneficiaries 110. The giver 110 may be able to select a specific beneficiary 110 (the farmer) and allocate funds for the project. Once funded, the farmer can repay the loan, and may be able to communicate with the givers 100 regarding the progress of the project and other things.

Miscellaneous

The gift processing system may be administrated by one or more individuals, one or more business entities, and/or one or more software programs that alone or in combination function as a gift processing system or administer a gift processing system. Although the the present invention has been discussed as including entities such as givers, beneficiaries, employers, payroll processors and financial institution, these entities may be external to the present invention. For example, the present invention may be a software program that uses or is used by an existing financial institution to implement the present invention. Steps carried out by the system such as administering, directing, monitoring, controlling, and facilitating may be carried out as described in this specification or by one skilled in the art. For example, if a business entity “administers” the establishment of a gift processing system it may be that the financial institution actually establishes the account(s) while the business entity requests the account(s) be established and verifies the establishment of the account(s).

It should be noted that there be security means included in the present invention not specifically discussed herein. For example, identification codes (e.g. an identification number), passwords, digital signatures, and other security means may be used interchangeably or in combination.

It should be noted that the term “money” is meant to include other valuable consideration including, but not limited to airline mileage, promotional points, tokens, coupons, and any other valuable consideration. For example, the present invention may include gifts of promotional points or air miles. On one alternative embodiment of the present invention, these alternative sources of valuable consideration may be maintained by a system outside the system maintained by the gift processing system. It should be noted that the terms “bill pay” and “payroll” are meant to be exemplary and should be considered as examples of other predictable payment systems that deposit a sufficiently predictable dollar amount into an account on a regular basis (e.g., a regular distribution from a retirement account).

It should be noted that the various entities discussed in this specification are meant to be exemplary. The various entities may “wear different hats” by functioning in multiple ways. For example, a beneficiary may also function as a giver. Another example is a giver financial institution may function as a giver. It should also be noted that additional entities (e.g. facilitators) may be added to entities discussed in the invention. For example when gift is made in a will, the executor of the will arrange for the gift to be distributed as desired by the deceased. Another exemplary facilitator may be that when a giver makes a gift or a beneficiary receives funds, additional intermediary facilitators may be used to complete the transaction. It should be noted that a giver may be employed by more than one employer. Similarly, more than one person (e.g. a married couple) may be a giver that is referenced by the unique identification number. Similarly, the gift management organization may be a group of organizations performing different or similar components of this invention.

It should be noted that a gift processing system may be a single system or a group of separate systems performing the functions of a gift processing system. A gift processing system may involve multiple separate gift processing system working separately or working in together, for example multiple systems synchronized providing backup functionality in case of a data center failure, or multiple systems distributed geographically each with their own geographic region.

It should be noted that technical terms such as “system,” “web site,” “computer,” “email,” and “database,” are meant to be exemplary and do not limit the scope of the invention. For example, “email” may be replaced with a voice mail or text messaging. As another example, a web site may be any type of communication method and/or device with a giver or beneficiary known or yet to be developed, like a mobile app on a mobile device, and ATM, or a kiosk.

For the purpose of consistency, in this application every attempt was made to use terminology consistently. It should be noted, however, that alternative embodiments are possible and are not excluded from the scope of the invention. For example, although many of the examples are discussed in terms of gifts of money it is possible that the same examples would work equally as well with gift items or services. Another example is that although the specification may specify that a web site is performing a particular function, it may be possible that a separate program (e.g. a mobile app) or a living entity could be performing the same function. Yet another example is that terms such as “deposit” and “transfer” may be used interchangeably if one skilled in the art would understand how to convert between the two (e.g. funds may be physically deposited or electronically transferred).

The terms and expressions that have been employed in the foregoing specification are used as terms of description and not of limitation, and are not intended to exclude equivalents of the features shown and described or portions of them. The scope of the invention is defined and limited only by the claims that follow.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A network configured to permit at least one gift consisting of at least one transfer of funds from at least one giver and at least one transfer of funds to at least one beneficiary, the network comprising:
at least one gift processing system managed by at least one gift management organization, at least one giver and at least one beneficiary having access to the gift processing system;
at least one gifting source, the gifting source being a source of funds for the giver and being capable of transferring funds to the gift management organization, a gifting source being an entity that manages customer funds in some form of currency that can be transferred;
at least one beneficiary financial institution, the beneficiary having an account at the beneficiary financial institution and the beneficiary financial institution capable of receiving funds from the gift management organization, a financial institution being an entity that manages customer accounts containing some form of currency that can be transferred;
wherein the gifting source is configured such that the giver can arrange for a single or recurring transfer of funds to the gift management organization, and wherein the gifting source transfers funds to the gift management organization;
wherein the gift processing system is configured such that funds received from the gifting source can be identified as from the giver;
wherein the gift processing system is configured such that the giver can arrange for the single or recurring distribution of funds to at least one selected beneficiary, and wherein the gift processing system transfers funds to the beneficiary within the gift processing system;
wherein the gift management organization is configured to transfer funds to the beneficiary account at the beneficiary financial institution; and,
wherein the gift processing system is configured such that the giver can receive at least one consolidated charitable receipt for gifts.

2. The network of claim 1 wherein the gift management organization can be structured legally as a non-profit entity, wherein the gift management organization can produce the consolidated charitable receipt where all gifts received from the giver are considered gifts to the gift management organization, and where the date of each gift can be set as the date the funds arrive at the gift management organization.

3. The network of claim 1 wherein the at least one gifting source can be at least one of the following:
an Employer;
a Payroll Processor;
a pension fund;
a Bank;
a Credit Union;
a Building Society;
a Government;
an Employer, where the currency is something of value that can be built up over time and has value, for example hours of overtime;
an Airline, where the currency is frequent flier miles;
a Retailer, where the currency is frequent buyer points; and,
an other entity, where the currency can be transferred.

4. The network of claim 1 wherein the at least one financial institution can be at least one of the following:
a Bank;
a Credit Union;
a Building Society;
a Government;
an Employer, where the currency is something of value that can be built up over time and has value, for example hours of overtime;
an Airline, where the currency is frequent flier miles;
a Retailer, where the currency is frequent buyer points; and,
an other entity, where the currency can be transferred.

5. The network of claim 1 wherein the at least one gifting source can be at least one of the following:
an Employer, where the funds come from employee salary or other forms of compensation;
a Payroll Processor, where the funds come from employee salary or other forms of compensation;
a Pension Fund, where the funds come from a recurring pension distribution;
a Financial Institution, where the funds come from an account;
a Bill Pay System, where the funds come from at attached account at a financial institution; and,
an other entity, being a source of funds for the giver.

6. The network of claim 1 wherein the gift processing system identification of the giver of received funds can be at least one of the following:
the giver can create a giver identifier, the giver can provide the giver identifier to the gifting source, and the transfer of funds from the gifting source to the gift management organization can include the giver identifier;
the transfer of funds from the gifting source to the gift management organization can include a customer identifier such as an account number or a social security number, and the giver can provide the customer identifier to the gift processing system;
the transfer of funds from the gifting source to the gift management organization could consist of some form of pulling of funds from the gifting source, such as a credit card transaction or an interbank transfer pull;
the method of transfer of funds could have integrated in it the identification of the giver within the gift processing system; and,
some other method of identifying the giver associated with received funds.

7. The network of claim 1 wherein the transfer of funds from the gift management organization to the beneficiary account at the beneficiary financial institution can be at least one of the following:
a charitable donation;
a gift;
a grant;
a scholarship;
a sponsorship;
a loan;
some other funds transfer descriptor;
an internal bank transfer of funds;
an interbank transfer of funds;
a check;
using a bill pay system;
using some other banking method of transferring funds;
a cash withdrawal at an ATM;
some other method of transferring funds;
on a periodic basis;
on reaching specified funding amounts;
on a specific date;
on the request of the beneficiary;
on the request of the giver;
on request of the gift management organization;
on receipt of a gift; and,
on some other event;

8. The network of claim 1 wherein the gift processing system is further configured such that the beneficiary can create at least one beneficiary project, and wherein the giver can distribute funds to the beneficiary project, the beneficiary project further configured with at least one of the following:
the beneficiary project has a project name;
the beneficiary project has a description;
the beneficiary project has a target amount;
the beneficiary project has a target date; and,
some other configuration;

9. The network of claim 1 further configured to include at least one project platform, the project platform comprising:
at least one giver, at least one producer and at least one beneficiary having access to the project platform;
wherein a producer can add at least one products into the project platform;
wherein a beneficiary can select at least one products in the project platform creating at least one beneficiary projects; and,
wherein a giver can select at least one beneficiary projects in the project platform for gift distribution.

10. The network of claim 9 wherein the giver selecting of the beneficiary projects can be by performing a search on at least one of the following:
beneficiary;
beneficiary type;
beneficiary geographic region;
beneficiary financial status;
producer;
producer type;
project;
project type;
project cost;
project funding availability; and,
some other search criterion.

11. The network of claim 1 wherein the access to the gift processing system can be at least one of the following:
a phone;
an ATM;
a computer with access to a gift processing system web site;
a smartphone with access to a gift processing system web site;
an other device with access to a gift processing system web site;
a smartphone with the ability to load and run a gift processing system mobile app; and
an other device with communication capabilities that can communicate with the gift processing system.
